(19) United States
(12) Patent Application Publication
(10) Pub. No.: US 2023/0076267 A1
(43) Pub. Date: Mar. 9, 2023

(54) REAL-TIME LOCATION OF AN OBJECT USING RADIO FREQUENCY AND INFRARED SIGNALS

(71) Applicant: SIGNIFY HOLDING B.V., EINDHOVEN (NL)

(72) Inventor: JAIGANESH BALASUBRAMANIAN, PEACHTREE CITY, GA (US)

(21) Appl. No.: 17/800,959

(22) PCT Filed: Feb. 19, 2021
(86) PCT No.: PCT/EP2021/054168

§ 371 Date: Aug. 19, 2022

Related U.S. Application Data
(60) Provisional application No. 62/982,936, filed on Feb. 28, 2020.

(30) Foreign Application Priority Data
Apr. 20, 2020 (EP) 20170424.4

(51) Int. Cl. G01S 5/02; G01S 5/00; H04W 4/80; H04B 17/318

(52) U.S. Cl. CPC G01S 5/02585; G01S 5/018; H04W 4/80; H04B 17/318

(57) ABSTRACT

The invention provide a system for locating an object in a volume of space, comprising: a communication device (CD) of the object disposed in the volume of space, wherein the communication device comprises a CD radio frequency (RF) receiver, a CD RF transmitter, and a CD infrared (IR) receiver; a first electrical device of a plurality of electrical devices disposed in the volume of space, wherein the first electrical device comprises at least one first sensor, a first RF receiver, a first IR transmitter, and a first RF transmitter, wherein the first RF transmitter broadcasts a first communication signal, wherein the first IR transmitter broadcasts a second communication signal, and wherein the first RF receiver receives, in response to the first communication signal received by the CD RF receiver and the second communication signal received by the CD IR receiver, a third communication signal broadcast by the CD RF transmitter of the communication device; and a controller communicably coupled to the plurality of electrical devices, wherein the controller receives a fourth communication signal sent by the first RF transmitter of the first electrical device, wherein the fourth communication signal comprises a first identification of the object and a second identification of the first electrical device, wherein the fourth communication signal is associated with a signal strength of the third communication signal received by the first RF receiver of the first electrical device.

### TECHNICAL FIELD

Embodiments described herein relate generally to locating objects in a space, and more particularly to systems, methods, and devices for locating objects in real time in a connected system.

### BACKGROUND

Different methods are used to locate an object within a volume of space. For example, when signals (e.g. radio frequency (RF) signals) are involved, the strength of each signal can be measured to help determine the location of an object within a volume of space. When the location is determined in real-time, the system to implement this process is often referred to as a real-time location system (RLTS).

### BRIEF DESCRIPTION OF THE DRAWINGS

The drawings illustrate only example embodiments of real-time location of an object using multiple electrical devices and are therefore not to be considered limiting of its scope, as real-time location of an object using multiple electrical devices may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a diagram of a system in accordance with certain example embodiments.

FIG. 2 shows a computing device in accordance with certain example embodiments.

FIG. 3 shows a diagram of another system in accordance with certain example embodiments.

FIG. 4 shows a lighting system in a healthcare environment in accordance with certain example embodiments.

FIG. 5 shows a lighting system in a manufacturing environment in accordance with certain example embodiments.

FIGS. 6A and 6B show a side and top view, respectively, of a system in which an object is located in a volume of space in accordance with certain example embodiments.

FIG. 7 shows the system of FIGS. 6A and 6B when a signal is sent by one of the light fixtures in accordance with certain example embodiments.

FIG. 8 shows the system of FIGS. 6A through 7 when a signal is sent by the object in accordance with certain example embodiments.

FIG. 9 shows a diagram of an integrated sensor module in accordance with certain example embodiments.

FIG. 10 shows a diagram of communication device of an object in accordance with certain example embodiments.

### DETAILED DESCRIPTION OF EXAMPLE EMBODIMENTS

The example embodiments discussed herein are directed to systems, methods, and devices for real-time location of an object using multiple electrical devices. While example embodiments are described herein as using multiple light fixtures to locate an object in a volume of space, example embodiments can use one or more of a number of other electrical devices in addition to, or as an alternative to, light fixtures. Such other electrical devices can include, but are not limited to, a light switch, a control panel, a thermostat, an electrical wall outlet, a sensor device (e.g., a smoke detector, a CO₂ monitor, a motion detector, a broken glass sensor), an integrated sensor device (defined below), and a camera.

Further, any of a number of location methods can be used with example embodiments to locate one or more objects in real-time (using RLTS). Examples of such location methods can include, but are not limited to, measurement of signal strength, measurement of frequency, time-of-flight (ToF), angle of arrival (AoA), and angle of departure (AoD). Any of these methods can involve measurements of one or more other parameters with respect to signals. Examples of such other parameters can include, but are not limited to, signal strength, frequency, distance of travel, angle, and time. These parameters can be measured in absolute values or in terms of differences (e.g., between transmitted and received signals).

Example embodiments can be used for a volume of space having any size and/or located in any environment (e.g., indoor, outdoor, hazardous, non-hazardous, high humidity, low temperature, corrosive, sterile, high vibration). Further, while signals described herein are RF signals, example embodiments can be used with any of a number of other types of signals and/or platform, including but not limited to visible light signals, LiFi, WiFi, Bluetooth, Bluetooth Low Energy (BLE), ultra-wideband, RFID, ultraviolet waves, microwaves, and infrared signals. For example, RF signals transmitted using BLE are sent and received at approximately 2.4 GHz.

When an electrical device in an example system is a light fixture (also called a luminaire), the light fixture can be any of a number of types of light fixtures, including but not limited to a troffer, a pendant light fixture, a floodlight, a spotlight, an emergency egress fixture, an exit sign, a down can light fixture, and a high bay light fixture. Regardless of the type of light fixture, such a light fixture can use one or more of a number of different types of light sources, including but not limited to light-emitting diode (LED) light sources, fluorescent light sources, organic LED light sources, incandescent light sources, and halogen light sources. Therefore, light fixtures described herein, even in hazardous locations, should not be considered limited to a particular type of light source.

Example embodiments provide various methods to accurately locate an object in a volume of space in real time. Example embodiments can be used to locate an object in real time in two dimensions or in three dimensions using RTLS structures. Example embodiments are also more reliable and accurate compared to location methods used in the current art. Example embodiments can be installed with new electrical (e.g., lighting, security, entertainment, HVAC) systems. Example embodiments can additionally or alternatively be programmed into existing electrical systems and related equipment with little to no need to add or modify existing hardware.

In certain example embodiments, electrical devices used for real-time location of an object are subject to meeting certain standards and/or requirements. For example, the National Electric Code (NEC), the National Electrical Manufacturers Association (NEMA), the International Electrotechnical Commission (IEC), the Federal Communication Commission (FCC), and the Institute of Electrical and Electronics Engineers (IEEE) set standards as to electrical enclosures (e.g., light fixtures), wiring, and electrical connections. Use of example embodiments described herein meet (and/or allow a corresponding device to meet) such standards when required. In some (e.g., PV solar) applications, additional standards particular to that application may be met by the electrical enclosures described herein.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of real-time location of an object using multiple electrical devices will be described more fully hereinafter with reference to the accompanying drawings, in which example embodiments of real-time location of an object using multiple electrical devices are shown. Real-time location of an object using multiple electrical devices may, however, be embodied in many different forms and should not be construed as limited to the example embodiments set forth herein. Rather, these example embodiments are provided so that this disclosure will be thorough and complete, and will fully convey the scope of real-time location of an object using multiple electrical devices to those or ordinary skill in the art. Like, but not necessarily the same, elements (also sometimes called components) in the various figures are denoted by like reference numerals for consistency.

Terms such as “first”, “second”, and “within” are used merely to distinguish one component (or part of a component or state of a component) from another. Such terms are not meant to denote a preference or a particular orientation, and such terms are not meant to limit embodiments of real-time location of an object using multiple electrical devices. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

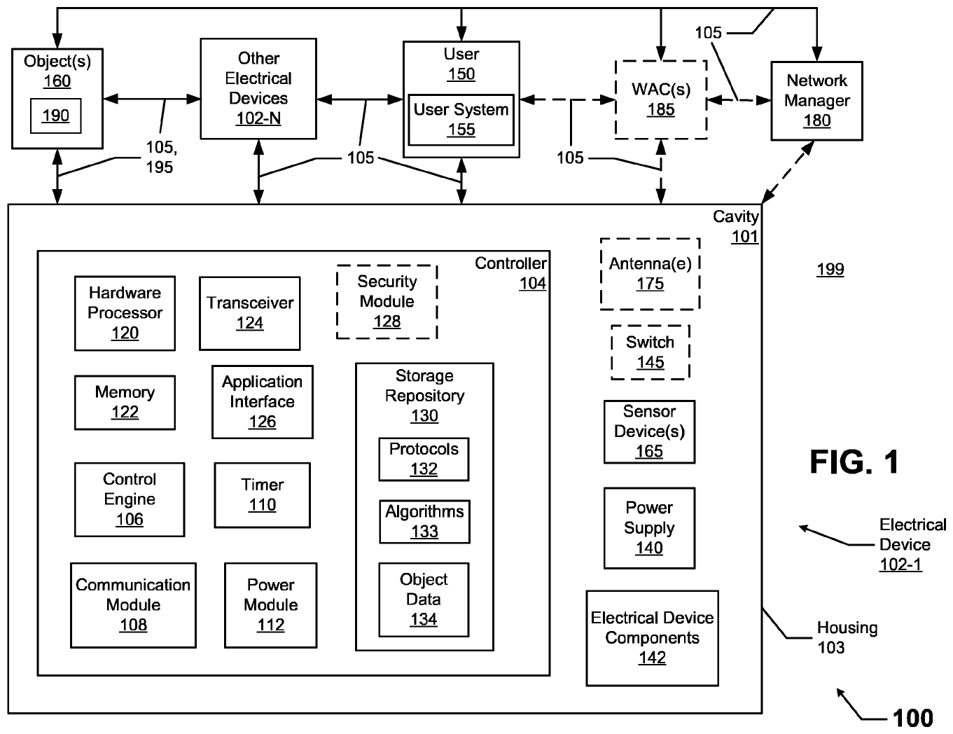

FIG. 1 shows a diagram of a system 100 that includes multiple electrical devices 102 and one or more objects 160 in a volume of space 199 in accordance with certain example embodiments. The system 100 can also include a user 150, a network manager 180, and one or more optional wireless access controllers 185 (WACs 185). Each electrical device 102 (e.g., electrical device 102-1, one or more other electrical devices 102-N) can include a controller 104, one or more sensor devices 165, one or more optional antennae 175, an optional switch 145, a power supply 140, and a number of electrical device components 142. The controller 104 can include one or more of a number of components. Such components, can include, but are not limited to, a control engine 106, a communication module 108, a timer 110, a power module 112, a storage repository 130, a hardware processor 120, a memory 122, a transceiver 124, an application interface 126, and, optionally, a security module 128.

Electrical device 102-1 and the other electrical devices 102-N can collectively be referred to as electrical devices 102. The components shown in FIG. 1 are not exhaustive, and in some embodiments, one or more of the components shown in FIG. 1 may not be included in an example electrical device 102. Any component of the example electrical device 102-1 can be discrete or combined with one or more other components of the electrical device 102-1. For example, each electrical device 102 in the system 100 can have its own controller 104. Alternatively, one controller 104 can be used to control multiple electrical devices 102 in the system. An electrical device 102 is any device that uses electricity, at least in part, to operate. A list of some potential electrical devices 102 is described above.

A user 150 may be any person that interacts with an electrical device 102 and/or object 160 in the volume of space 199. Specifically, a user 150 may program, operate, and/or interface with one or more components (e.g., a controller, the network manager 180) associated with the system 100 using example embodiments. Examples of a user 150 can include, but are not limited to, an employee, an engineer, an electrician, a technician, an operator, a consultant, a contractor, an asset, a network manager, and a manufacturer's representative.

The user 150 can use a user system 155 (sometimes also called a user device 155), which may include a display (e.g., a GUI). The user 150 (including a user system 155) interacts with (e.g., sends data to, receives data from) the controller 104 of an electrical device 102 via the application interface 126 (described below). A user 150 (including a user system 155) can also interact with the network manager 180, the sensor devices 165, the WACs 185, and/or one or more of the objects 160 (including associated communication devices 190). Interaction (including transmission of communication signals 195) between a user 150 (including a user system 155) and the electrical devices 102, the network manager 180, the WACs 185, the sensor devices 165, and the objects 160 (including associated communication devices 190) can be facilitated using communication links 105.

Each communication link 105 can include wired (e.g., Class 1 electrical cables, Class 2 electrical cables, electrical connectors, Power Line Carrier, RS485, DALI) and/or wireless (e.g., Wi-Fi, visible light communication, cellular networking, Bluetooth, BLE, ultra-wideband, Zigbee, WirelessHART, ISA100) technology. For example, a communication link 105 can be (or include) one or more electrical conductors that are coupled to the housing 103 of an electrical device 102 and to the network manager 180. The communication links 105 can transmit signals (e.g., power signals, communication signals 195) between the electrical devices 102, a user 150 (including a user system 155), the sensor devices 165, the objects 160 (including communication devices 190), the WACs 185, and/or the network manager 180.

For example, the electrical devices 102 of the system 100 can interact with the one or more objects 160 by transmitting communication signals 195 (e.g., instructions, data, control) over one or more communication links 105, as discussed below. The communication signals 195 transmitted over the communication links 105 are made up of bits of data. As described herein, the communication signals 195 can be one or more of any type of signal, including but not limited to RF signals, infrared signals, visible light communication, and sound waves.

The network manager 180 is a device or component that controls all or a portion of the system 100 that includes the controller 104 of at least one of the electrical devices 102 and the WACs 185. The network manager 180 can be substantially similar to the controller 104 and/or a WAC 185. Alternatively, the network manager 180 can include one or more of a number of features in addition to, or altered from, the features of the controller 104 and/or a WAC 185, both described below. There can be more than one network manager 180 and/or one or more portions of a network manager 180.

In some cases, a network manager 180 can be called by a number of other names known in the art, including but not limited to an insight manager, a master controller, a network controller, and a RTLS engine. When WACs 185 are included in the system 100, the network manager 180 receives data from the WACs 185 and processes this data (e.g., using algorithms 133 and/or protocols 132) to determine the location of one or more objects 160 in real time. The network manager 180 can be located in the volume of space 199 or remotely from the volume of space 199. The network manager 180 can use the various communications received from the WACs 185 (or directly from the electrical devices 102) to locate an object 160 in two dimensions or in three dimensions within the volume of space 199 in real time.

Each WAC 185 (sometimes called a wireless area controller or more simply an access controller, as a generic term and/or when wired communication links 105 are involved) performs a number of different functions. For example, a WAC 185 can help communicate with and control the controller 104 of one or more electrical devices 102 to help control the operation of those electrical devices 102. For some RTLS applications, the WAC 185 can additionally or alternatively be responsible for pairing with the Zigbee-enabled (or some other protocol-enabled) sensor devices 165, providing configuration data to the sensor devices 165, synchronizing the timing of those sensor devices 165, supporting the firmware of those sensor devices 165, upgrading those sensor devices 165, receiving location/telemetry data (e.g., using a Zigbee-enabled communication links 105) from the sensor devices 165, and/or performing any other function with respect to those sensor devices 165 to support RTLS activities.

When a WAC 185 receives data (e.g., packed egress data that arrives as ingress data) from a sensor device 165, the WAC 185 can convert the data into a different format. The WAC 185 can then send the newly-formatted data to the network manager 180. To help diagnose issues, a WAC 185 can maintain counters for each paired sensor device 165 and include, for example, the number of received packed data messages from a particular sensor device 165, the number of formatted messages successfully transmitted to the network manager 180 that pertain to the packed data from a particular sensor device 165, and the number of formatted messages pertaining to the packed data from a particular sensor device 165 that failed to transmit to the network manager 180.

In some cases, a WAC 185 maintains the average and maximum latency introduced between the receipt of a message from a sensor device 165 and transmission of a formatted message to the network manager 180. The WAC 185 can also notify the network manager 180 when the average or maximum latency exceeds a threshold value. Further, a WAC 185 can communicate to the network manager 180 when there is a significant discrepancy (e.g., as determined by the WAC 185) between the ingress and egress packets with respect to a sensor device 165. When there are multiple WACs 185, they can all be time-synchronized with each other. In some cases, the functionality of a WAC 185 can be the same as, or at least partially combined with, the functionality of the controller 104 of an electrical device 102. A WAC 185 can be located in the volume of space 199 or remotely from the volume of space 199.

As defined herein, an object 160 can be any unit or group of units. An object 160 can move on its own, is capable of being moved, or is stationary. Examples of an object 160 can include, but are not limited to, a person (e.g., a user 150, such as a visitor or an employee), a part (e.g., a motor stator, a cover), a piece of equipment (e.g., a fan, a container, a table, a chair), or a group of parts of equipment (e.g., a pallet stacked with inventory). A system 100 can have one object 160 or multiple objects 160 in the volume of space 199 at a given point in time.

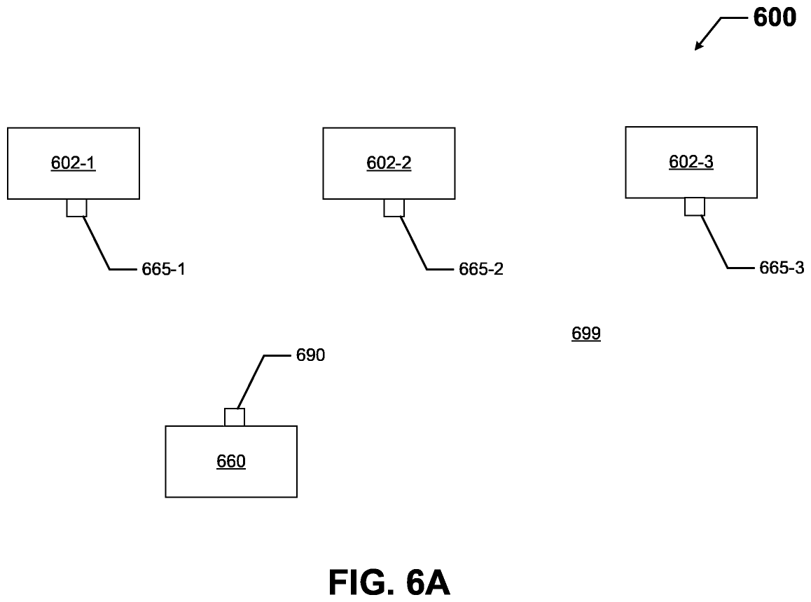

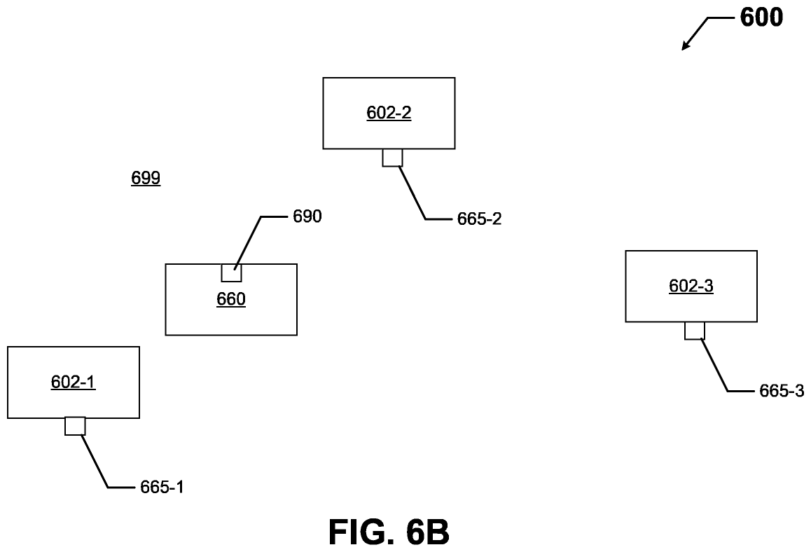

Each object 160 can include a communication device 190 (also sometimes called a tag, a beacon, or other name known in the art, depending on the configuration of the communication device 190), which can receive communication signals 195 from and/or send communication signals 195 to one or more electrical devices 102. The communication device 190 of an object 160 can broadcast communication signals 195 that can be received by any electrical devices 102 within range (discussed below with respect to FIGS. 6A through 8) of the broadcast or send communication signals 195 addressed to electrical devices 102. A communication device 190 can take one or more of a number of forms, including but not limited to an ID badge, a sticker, a hand-held device, and a wearable item (e.g., a hat, a shirt).

A communication device 190 can include one or more of a number of components (e.g., transceiver, antenna, switch, power module) and/or have the functionality described below with respect to a controller 104 and/or an associated electrical device 102. For example, a communication device 190 can include a control engine, a transceiver, and an antenna to allow the communication device 190 to send communication signals 195 to and/or receive communication signals 195 from one or more electrical devices 102 in the system 100.

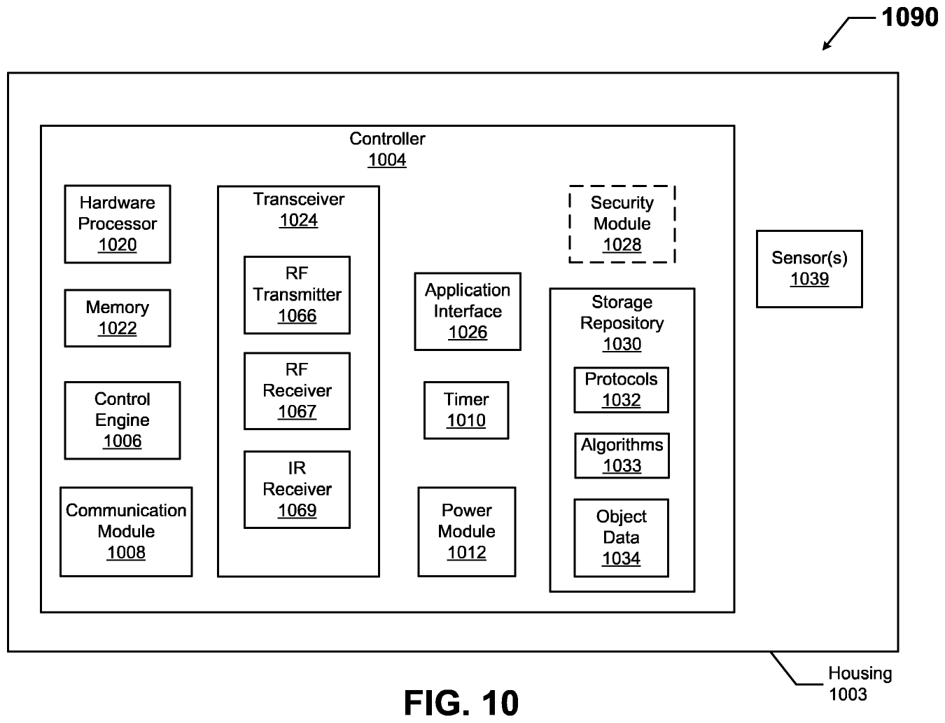

In certain example embodiments, the communication device 190 can also include one or more other components that are not described below with respect to the controller 104 and/or an associated electrical device 102. For example, a communication device 190 of an object 160 can include an infrared receiver as part of the transceiver of the communication device 190. In such a case, the infrared receiver can be used to receive IR signals (types of communication signals 195) broadcast by the electrical device 102-1 (or portion thereof, such as a sensor device 165). An example of a communication device with an infrared receiver is shown below in FIG. 10.

Using example embodiments, a communication device 190 of an object 160 can be in sleep mode for a predefined interval, at which point it stays awake for a period of time or until the communication device 190 receives one or more communication signals 195 (e.g., an IR signal, a RF signal, both) broadcast by one or more electrical devices 102. When this occurs, the communication device 190 can turn on long enough to interpret the initial communication signal 195, and then generate and send its own communication signal 195 (e.g., a RF signal) to one or more of the electrical devices 102 in response to the one or more initial communication signals 195. This response communication signal 195 can include a UUID (or other form of identification) as well as a reference (e.g., signal code) to the initial communication signal 195 and/or the electrical device 102 that sent the initial communication signal 195, if any. Once the response communication signal 195 is sent by a communication device 190, the communication device 190 can go back into sleep mode, thereby reserving a considerable amount of power.

The communication device 190 can use one or more of a number of communication protocols in sending communication signals 195 to and/or receiving communication signals 195 from the electrical devices 102. In certain example embodiments, an object 160 (or a portion thereof, such as the communication device 190) can include a battery (a form of power supply or power module) that is used to provide power, at least in part, to some or all of the rest of the object 160 and/or the communication device 190.

A user 150 (including a user system 155), the network manager 180, one or more sensor devices 165, one or more WACs 185, an object 160 (including an associated communication device 190), and/or the other electrical devices 102-N can interact with the controller 104 of the electrical device 102-1 using the application interface 126 in accordance with one or more example embodiments. Specifically, the application interface 126 of the controller 104 receives data (e.g., information, communications, instructions) from and sends data (e.g., information, communications, instructions) to a user 150 (including a user system 155), the objects 160 (including communication devices 190), the network manager 180, the sensor devices 165, one or more WACs 185, and/or one or more of the other electrical devices 102-N.

A user 150 (including a user system 155), the network manager 180, the sensor devices 165, one or more WACs 185, an object 160 (including an associated communication device 190), and/or one or more of the other electrical devices 102-N can include an interface to receive data from and send data (e.g., using communication signals 195) to the controller 104 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

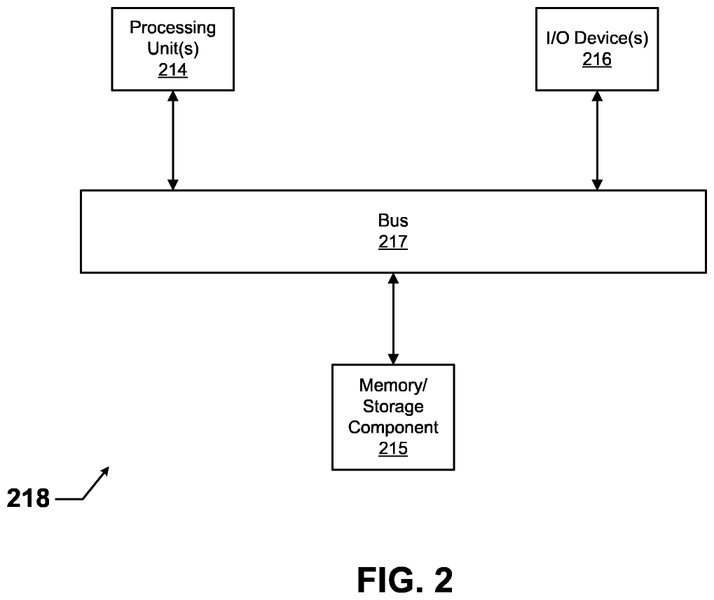

The controller 104, a user 150 (including a user system 155), the network manager 180, the sensor devices 165, one or more WACs 185, an object 160 (including an associated communication device 190), and/or one or more of the other electrical devices 102-N can use their own system or share a system in certain example embodiments. Such a system can be, or contain a form of, an Internet-based or an intranet-based computer system that is capable of communicating with various software. A computer system includes any type of computing device and/or communication device, including but not limited to the controller 104. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 2.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

The electrical device 102-1 can include a housing 103. The housing 103 can include at least one wall that forms a cavity 101. In some cases, the housing 103 can be designed to comply with any applicable standards so that the electrical device 102-1 can be located in a particular environment (e.g., a hazardous environment, a climate-controlled environment, a humid environment). The housing 103 of the electrical device 102-1 can be used to house one or more components of the electrical device 102-1, including one or more components of the controller 104.

For example, as shown in FIG. 1, the controller 104 (which in this case includes the control engine 106, the communication module 108, the timer 110, the power module 112, the storage repository 130, the hardware processor 120, the memory 122, the transceiver 124, the application interface 126, and the optional security module 128), the one or more sensor devices 165, an optional switch 145, one or more optional antennae 175, the power supply 140, and the electrical device components 142 are disposed in the cavity 101 formed by the housing 103. In alternative embodiments, any one or more of these or other components of the electrical device 102-1 can be disposed on the housing 103 and/or remotely from the housing 103.

The storage repository 130 can be a persistent storage device (or set of devices) that stores software and data used to assist the controller 104 in communicating with a user 150 (including a user system 155), the network manager 180, the communication device 190 of one or more of the objects 160 (including associated communication devices 190), the sensor devices 165, one or more WACs 185, and one or more of the other electrical devices 102-N within the system 100. In one or more example embodiments, the storage repository 130 stores one or more protocols 132, one or more algorithms, 133, and object data 134.

The protocols 132 can be any procedures (e.g., a series of method steps) and/or other similar operational procedures that the control engine 106 of the controller 104 follows based on certain conditions at a point in time. The protocols 132 can also include any of a number of communication protocols that are used to send and/or receive data between the controller 104 and a user 150 (including a user system 155), the network manager 180, the one or more of the other electrical devices 102-N, the sensor devices 165, one or more WACs 185, and one or more of the objects 160 (including a communication device 190). One or more of the protocols 132 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 132 used for communication can provide a layer of security to the data transferred within the system 100.

The algorithms 133 can be any formulas, mathematical models, forecasts, simulations, and/or other similar tools that the control engine 106 of the controller 104 uses to reach a computational conclusion. An example of one or more algorithms 133 is calculating the strength of a communication signal 195 and comparing the strength of a communication signal 195 with a threshold value. Algorithms 133 can be used to analyze past data, analyze current data, and/or perform forecasts.

One or more particular algorithms 133 can be used in conjunction with one or more particular protocols 132. For example, one or more protocols 132 and one or more algorithms 133 can be used in conjunction with each other to track an object 160 using occupancy information measured by one or more sensor devices 165. As another example, one or more protocols 132 and one or more algorithms 133 can be used in conjunction with each other to track an object 160 using encoded IR signaling, which can involve one or more sensor devices 165. As still another example, one or more protocols 132 and one or more algorithms 133 can be used in conjunction with each other to track an object 160 based on a temporal separation of objects 160 based on a received signal strength indicator (RSSI), which can be measured by one or more sensor devices 165.

Object data 134 can be any data associated with each object 160 (including an associated communication device 190) that is communicably coupled to the controller 104. Such data can include, but is not limited to, a manufacturer of the object 160, a model number of the communication device 190 of an object 160, communication capability of the communication device 190 of an object 160, last known location of the object 160, and age of the object 160. Examples of a storage repository 130 can include, but are not limited to, a database (or a number of databases), a file system, a hard drive, flash memory, cloud-based storage, some other form of solid state data storage, or any suitable combination thereof.

The storage repository 130 can be located on multiple physical machines (e.g., the controller 104, the network manager 180, the cloud), each storing all or a portion of the protocols 132, the algorithms 133, and/or the object data 134 according to some example embodiments. Each storage unit or device can be physically located in the same or in a different geographic location. The storage repository 130 can also store other types of information, including but not limited to user preferences, threshold values, historical data, software and firmware updates, notifications, forecasts, tables, information about other electrical devices 102-N, information about one or more WACs 185, and information about the network manager 180.

The storage repository 130 can be operatively connected to the control engine 106. In one or more example embodiments, the control engine 106 includes functionality to communicate with a user 150 (including a user system 155), the network manager 180, the objects 160 (including communication devices 190), the sensor devices 165, one or more WACs 185, and the other electrical devices 102-N in the system 100. More specifically, the control engine 106 sends information to and/or receives information from the storage repository 130 in order to communicate with a user 150 (including a user system 155), the network manager 180, the objects 160 (including communication devices 190), the sensor devices 165, one or more WACs 185, and the other electrical devices 102-N. As discussed below, the storage repository 130 can also be operatively connected to the communication module 108 in certain example embodiments.

In certain example embodiments, the control engine 106 of the controller 104 controls the operation of one or more components (e.g., the communication module 108, the timer 110, the transceiver 124) of the controller 104. For example, the control engine 106 can put the communication module 108 in “sleep” mode when there are no communications between the controller 104 and another component (e.g., a communication device 190 of an object 160, a sensor device 165, a WAC 185, a user system 155) in the system 100 or when communications between the controller 104 and another component in the system 100 follow a regular pattern. In such a case, power consumed by the controller 104 is conserved by only enabling the communication module 108 when the communication module 108 is needed.

As another example, the control engine 106 can direct the timer 110 when to provide a current time, to begin tracking a time period, and/or perform another function within the capability of the timer 110. As yet another example, the control engine 106 can direct the transceiver 124 to send communication signals 195 (or other types of communication) and/or stop sending communication signals 195 (or other types of communication) to one or more sensor devices 165 and/or one or more WACs 185 in the system 100. The control engine 106 can also instruct a sensor device 165 to communicate with an object 160 (or a communication device 190 thereof), with a WAC 185, and/or with the controller 104. This example provides another instance where the control engine 106 can conserve power used by the controller 104 and other components (e.g., the communication devices 190 of the objects 160, the sensor devices 165) of the system 100.

The control engine 106 can determine when to broadcast one or more communication signals 195 in an attempt to locate an object 160. To conserve energy, the control engine 106 may not constantly broadcast communication signals 195, but rather may only do so at discrete times. The control engine 106 can broadcast a communication signal 195 based on one or more of a number of factors, including but not limited to passage of time, the occurrence of an event, instructions from a user 150 (including a user system 155), and a command received from the network manager 180. The control engine 106 can coordinate with the controllers 104 of one or more of the other electrical devices 102-N and/or directly control one or more of the other electrical devices 102-N to broadcast multiple communication signals 195.

The control engine 106 can also determine the signal strength (e.g., RSSI) of one or more of the communication signals 195 that are broadcast by the communication device 190 of an object 160, in some cases in response to the communication signal 195 broadcast by the electrical device 102-1. The control engine 106 can further determine, based on contents of a communication signal 195 received from a communication device 190, whether the communication device 190 received a prior communication signal 195, sent by the controller 104, in the form of an IR signal.

In some cases, the control engine 106 of the electrical device 102-1 (or, in some cases, the network manager 180 communicating with the controller 104) can locate the object 160 based on the multiple communication signals 195 sent by the communication device 190 of an object 160, in some cases in response to the multiple communication signals 195 (e.g., IR signals and RF signals) broadcast by one or more of the electrical devices 102. To accomplish this, the control engine 106 obtains the multiple communication signals 195 (directly and/or from another control engine 106 from one or more of the other electrical devices 102-N) broadcast by the communication device 190 of an object 160 and uses one or more protocols 132 and/or algorithms 133 to determine the location of the object 160.

As a specific example, the control engine 106 of the controller 104 can instruct the transceiver 124 to broadcast communication signals 195 in the form of both RF signals and IR signals. When a subsequent communication signal 195 is received by the transceiver 124 in response to the previously broadcast communication signals 195, the control engine 106 can determine whether the communication device 190 that sent the subsequent communication signal 195 received both the RF signals and IR signals of the previously broadcast communication signals 195. If not, the control engine 106 can decide, based on one or more protocols 132, to ignore the subsequent communication signal 195, and so not determine the location of the communication device 190. If so, the control engine 106 can decide, based on one or more protocols 132 and one or more algorithms 133, to use the data in and associated with the subsequent communication signal 195 to determine the location of the communication device 190 in the volume of space 199.

For example, the protocols 132 and/or algorithms 133 used by the control engine 106 can track an object 160 using occupancy information. Example embodiments can locate one or more objects 160 in a volume of space 199 in two or three dimensions. The control engine 106 of the controller 104 can also use the protocols 132 and/or the algorithms 133 to extract the ID of an object 160 from a communication signal (e.g., communication signal 195) received from the communication device 190 of the object 160 directly by the transceiver 124 or by an integrated sensor device 165. The control engine 106 of the controller 104 can also use the storage repository 130, the protocols 132, and/or the algorithms 133 to determine if the ID of the object 160 is among a list of IDs (e.g., stored in a table). Such a list can be used to determine whether subsequent communication generated by the control engine 106 is sent to a WAC 185 or the network manager 180.

The control engine 106 of the controller 104 can further use the protocols 132 and/or the algorithms 133 to interpret the measurements made by one or more of the sensors of the integrated sensor module 165. For instance, if the integrated sensor device 165 includes a PIR sensor, then the PIR sensor can detect motion within a sensing range and/or occupancy within a RTLS occupancy zone. In such a case, the control engine 106 can interpret these detections by the PIR sensor.

The control engine 106 of the controller 104 can also use the protocols 132 and/or the algorithms 133 to generate a subsequent communication signal to a WAC 185, another electrical device 102-N, and/or the network manager 180 that is based on receipt of one or more communication signals 195 received from a communication device 190. For example, a subsequent communication signal 195 can include a number of bits that are directed to information such as, for example, the ID of the object 160, the ID of the sensor device 165, and the RSSI of the communication signal communication signal 195 received by the sensor device 165 from a communication device 190.

The control engine 106 can provide control, communication, and/or other similar signals to a user 150 (including a user system 155), the network manager 180, the other electrical devices 102-N, the sensor devices 165, one or more WACs 185, and one or more of the objects 160 (including associated communication devices 190). Similarly, the control engine 106 can receive control, communication, and/or other similar signals from a user 150 (including a user system 155), the network manager 180, the other electrical devices 102-N, the sensor devices 165, one or more WACs 185, and one or more of the objects 160 (including associated communication devices 190). The control engine 106 can communicate with the communication device 190 of each object 160 automatically (for example, based on one or more algorithms 133 stored in the storage repository 130) and/or based on control, communication, and/or other similar signals received from another device (e.g., the network manager 180, another electrical device 102) using the communication signals 195. The control engine 106 may include a printed circuit board, upon which the hardware processor 120 and/or one or more discrete components of the controller 104 are positioned.

In certain example embodiments, the control engine 106 can include an interface that enables the control engine 106 to communicate with one or more components (e.g., power supply 140) of the electrical device 102-1. For example, if the power supply 140 of the electrical device 102-1 operates under IEC Standard 62386, then the power supply 140 can include a digital addressable lighting interface (DALI). In such a case, the control engine 106 can also include a DALI to enable communication with the power supply 140 within the electrical device 102-1. Such an interface can operate in conjunction with, or independently of, the communication protocols 132 used to communicate between the controller 104 and a user 150 (including a user system 155), the network manager 180, the other electrical devices 102-N, the sensor devices 165, one or more WACs 185, and the objects 160 (including associated communication devices 190).

The control engine 106 (or other components of the controller 104) can also include one or more hardware and/or software architecture components to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

By using example embodiments, while at least a portion (e.g., the control engine 106, the timer 110) of the controller 104 is always on, the remainder of the controller 104 and the communication devices 190 of the objects 160 can be in sleep mode when they are not being used. In addition, the controller 104 can control certain aspects (e.g., sending communication signals 195 to and receiving communication signals 195 from a communication device 190 of an object 160) of one or more other electrical devices 102-N in the system 100.

The communication network (using the communication links 105) of the system 100 can have any type of network architecture. For example, the communication network of the system 100 can be a mesh network. As another example, the communication network of the system 100 can be a star network. When the controller 104 includes an energy storage device (e.g., a battery as part of the power module 112), even more power can be conserved in the operation of the system 100. In addition, using time-synchronized communication protocols 132, the data transferred between the controller 104 and a user 150 (including a user system 155), the network manager 180, the sensor devices 165, one or more WACs 185, the objects 160 (including associated communication devices 190), and the other electrical devices 102-N can be secure.

The communication module 108 of the controller 104 determines and implements the communication protocol (e.g., from the protocols 132 of the storage repository 130) that is used when the control engine 106 communicates with (e.g., sends signals to, receives signals from) a user 150 (including a user system 155), the network manager 180, the other electrical devices 102-N, the sensor devices 165, one or more WACs 185, and/or one or more of the objects 160 (including associated communication devices 190). In some cases, the communication module 108 accesses the object data 134 to determine which communication protocol is within the capability of the communication device 190 of an object 160 for a communication signal 195 sent by the control engine 106. In addition, the communication module 108 can interpret the communication protocol of a communication (e.g., a communication signal 195) received by the controller 104 so that the control engine 106 can interpret the communication.

The communication module 108 can send data (e.g., protocols 132, object data 134) directly to and/or retrieve data directly from the storage repository 130. Alternatively, the control engine 106 can facilitate the transfer of data between the communication module 108 and the storage repository 130. The communication module 108 can also provide encryption to data that is sent by the controller 104 and decryption to data that is received by the controller 104. The communication module 108 can also provide one or more of a number of other services with respect to data sent from and received by the controller 104. Such services can include, but are not limited to, data packet routing information and procedures to follow in the event of data interruption.

The timer 110 of the controller 104 can track clock time, intervals of time, an amount of time, and/or any other measure of time. The timer 110 can also count the number of occurrences of an event, whether with or without respect to time. Alternatively, the control engine 106 can perform the counting function. The timer 110 is able to track multiple time measurements concurrently. The timer 110 can measure the time of flight (ToF) of one or more communication signals 195, even simultaneously. The timer 110 can track time periods based on an instruction received from the control engine 106, based on an instruction received from a user 150 (including a user system 155), based on an instruction programmed in the software for the controller 104, based on some other condition or from some other component, or from any combination thereof.

The power module 112 of the controller 104 provides power to one or more other components (e.g., timer 110, control engine 106) of the controller 104. In addition, in certain example embodiments, the power module 112 can provide power to the power supply 140 or other components of the electrical device 102-1. The power module 112 can include one or more of a number of single or multiple discrete components (e.g., transistor, diode, resistor), and/or a microprocessor. The power module 112 may include a printed circuit board, upon which the microprocessor and/or one or more discrete components are positioned.

The power module 112 can include one or more components (e.g., a transformer, a diode bridge, an inverter, a converter) that receives power (for example, through an electrical cable) from a source external to the electrical device 102 and generates power of a type (e.g., alternating current, direct current) and level (e.g., 12V, 24V, 120V) that can be used by the other components of the controller 104 and/or by other components (e.g., the power supply 140) of the electrical device 102-1. In addition, or in the alternative, the power module 112 can be or include a source of power in itself to provide signals to the other components of the controller 104 and/or the power supply 140. For example, the power module 112 can include an energy storage device (e.g., a battery). As another example, the power module 112 can include a localized photovoltaic power system.

The hardware processor 120 of the controller 104 executes software in accordance with one or more example embodiments. Specifically, the hardware processor 120 can execute software on the control engine 106 or any other portion of the controller 104, as well as software used by a user 150 (including a user system 155), the network manager 180, the sensor devices 165, one or more WACs 185, the objects 160 (including associated communication devices 190), and/or one or more of the other electrical devices 102-N. The hardware processor 120 can be or include an integrated circuit, a central processing unit, a multi-core processing chip, a multi-chip module including multiple multi-core processing chips, or other hardware processor in one or more example embodiments. The hardware processor 120 is known by other names, including but not limited to a computer processor, a microprocessor, and a multi-core processor.

In one or more example embodiments, the hardware processor 120 executes software instructions stored in memory 122. The memory 122 includes one or more cache memories, main memory, and/or any other suitable type of memory. The memory 122 is discretely located within the controller 104 relative to the hardware processor 120 according to some example embodiments. In certain configurations, the memory 122 can be integrated with the hardware processor 120.

In certain example embodiments, the controller 104 does not include a hardware processor 120. In such a case, the controller 104 can include, as an example, one or more field programmable gate arrays (FPGA), one or more insulated-gate bipolar transistors (IGBTs), one or more complex programmable logic devices (CPLDs), programmable array logics (PALs), one or more digital signal processors (DSPs), and/or one or more integrated circuits (ICs). Using FPGAs, IGBTs, CPLDs, PALs, DSPs, ICs, and/or other similar devices known in the art allows the controller 104 (or portions thereof) to be programmable and function according to certain logic rules and thresholds without the use of a hardware processor. Alternatively, FPGAs, IGBTs, CPLDs, PALs, DSPs, ICs, and/or similar devices can be used in conjunction with one or more hardware processors 120.

The transceiver 124 of the controller 104 can send (using a transmitter) and/or receive (using a receiver) control and/or communication signals 195. Specifically, the transceiver 124 can be used to transfer data between the controller 104 and a user 150 (including a user system 155), the network manager 180, the other electrical devices 102-N, one or more of the sensor devices 165, one or more WACs 185, and/or the objects 160 (including associated communication devices 190). The transceiver 124 can use wired and/or wireless technology.

The transceiver 124 can be configured in such a way that the communication signals 195 sent and/or received by the transceiver 124 can be received and/or sent by another transceiver that is part of a user 150 (including a user system 155), the network manager 180, the other electrical devices 102-N, one or more sensor devices 165, one or more WACs 185, and/or the objects 160 (including associated communication devices 190).

When the transceiver 124 uses wireless technology, any type of wireless technology can be used by the transceiver 124 in sending and receiving communication signals 195. Such wireless technology can include, but is not limited to, Wi-Fi, visible light communication, IR, cellular networking, Zigbee, ultra-wideband, BLE, and Bluetooth. For example, the transceiver 124 can include a Zigbee transmitter, a Zigbee receiver, a BLE receiver, a BLE transmitter, an active IR transmitter, and/or an active IR receiver. As another example, the transceiver 124 can include a Zigbee transmitter, a Zigbee receiver, an ultra-wideband receiver, an ultra-wideband transmitter, an active IR transmitter, and/or an active IR receiver.

In some cases, the transceiver 124 can include more than one transmitter and/or more than one receiver. For example, the transceiver 124 can include a RF transmitter, a RF receiver, and an IR transmitter. This would allow the electrical device 102-1 (or portion thereof) to broadcast to one or more communication devices 190 a communication signal 195 using RF signals and another communication signal 195 using IR. The RF receiver of the transceiver 124 can then subsequently receive a communication signal 195 from the one or more communication devices 190 in response to the RF and IR communications signals 195 broadcast by the transceiver 124.

The transceiver 124 can use one or more of any number of suitable communication protocols (e.g., ISA100, HART) when sending and/or receiving signals, including communication signals 195. Such communication protocols can be stored in the protocols 132 of the storage repository 130. Further, any transceiver information for a user 150 (including a user system 155), the network manager 180, the other electrical devices 102-N, the sensor devices 165, one or more WACs 185, and/or the objects 160 (including associated communication devices 190) can be part of the object data 134 (or similar areas) of the storage repository 130.

Optionally, in one or more example embodiments, the security module 128 secures interactions between the controller 104, a user 150 (including a user system 155), the network manager 180, the other electrical devices 102-N, the sensor devices 165, one or more WACs 185, and/or the objects 160 (including associated communication devices 190). More specifically, the security module 128 authenticates communication from software based on security keys verifying the identity of the source of the communication. For example, user software may be associated with a security key enabling the software of a user system 155 of a user 150 to interact with the controller 104 of the electrical device 102-1. Further, the security module 128 can restrict receipt of information, requests for information, and/or access to information in some example embodiments.

As mentioned above, aside from the controller 104 and its components, the electrical device 102-1 can include the power supply 140, one or more sensor devices 165, one or more optional antennae 175, the one or more optional switches 145, and one or more electrical device components 142. The electrical device components 142 of the electrical device 102-1 are devices and/or components typically found in the electrical device 102-1 to allow the electrical device 102-1 to operate. An electrical device component 142 can be electrical, electronic, mechanical, or any combination thereof. The electrical device 102-1 can have one or more of any number and/or type of electrical device components 142. For example, when the electrical device 102-1 is a light fixture, examples of such electrical device components 142 can include, but are not limited to, a light source, a light engine, a heat sink, an electrical conductor or electrical cable, a terminal block, a lens, a diffuser, a reflector, an air moving device, a baffle, a dimmer, and a circuit board.

The power supply 140 of the electrical device 102-1 can provide power to the controller 104, one or more of the electrical device components 142, the power supply 140, the one or more sensor devices 165, the one or more optional antennae 175, and/or the one or more optional switches 145. The power supply 140 can be substantially the same as, or different than, the power module 112 of the controller 104. The power supply 140 can include one or more of a number of single or multiple discrete components (e.g., transistor, diode, resistor), and/or a microprocessor. The power supply 140 may include a printed circuit board, upon which the microprocessor and/or one or more discrete components are positioned.

The power supply 140 can include one or more components (e.g., a transformer, a diode bridge, an inverter, a converter) that receives power (for example, through an electrical cable) from an external power source (e.g., AC mains) or, in some cases, the power module 112 of the controller 104. The power supply 140 can generate power of a type (e.g., alternating current, direct current) and level (e.g., 12V, 24V, 120V) that can be used by the recipients (e.g., the electrical device components 142, the controller 104) of such power. In addition, or in the alternative, the power supply 140 can be or include a source of power in itself. For example, the power supply 140 can include an energy storage device (e.g., a battery), a localized photovoltaic power system, or some other source of independent power.

Each of the one or more sensor devices 165 of the electrical device 102-1 can include any type of sensing device that measures one or more parameters. Examples of types of sensors of a sensor device 165 can include, but are not limited to, a passive infrared sensor, a photocell, a pressure sensor, an air flow monitor, a gas detector, and a resistance temperature detector. Examples of a parameter that is measured by a sensor of a sensor device 165 can include, but are not limited to, occupancy in the volume of space 199, motion in the volume of space 199, a temperature, a level of gas, a level of humidity, an amount of ambient light in the volume of space 199, and a pressure wave.

In some cases, the parameter or parameters measured by a sensor device 165 can be used to operate one or more of the electrical device components 142 of the electrical device 102-1. In addition, or in the alternative, the one or more parameters measured by a sensor device 165 can be used to locate one or more objects 160 in accordance with certain example embodiments. For example, if a sensor device 165 is configured to detect the presence of an object 160, that information can be used to determine whether a communication (e.g., a communication signal 195) received from a communication device 190 of an object 160 should be forwarded to a network manager 180.

A sensor device 165 can be an integrated sensor. An integrated sensor has both the ability to sense and measure at least one parameter and the ability to communicate with another component (e.g., the communication device 190 of an object 160, a WAC 185). The communication capability of a sensor device 165 that is an integrated sensor can include one or more communication devices that are configured to communicate with, for example, the controller 104 of the electrical device 102-1, a WAC 185, and/or a controller (substantially similar to the controller 104 described herein) of another electrical device 102-N. For example, an integrated sensor device 165 can include a passive infrared (PIR) sensor, a transceiver that sends and receives signals using Zigbee, a receiver that receives signals using BLE, and a receiver that actively receives IR signals. In such a case, the PIR sensor measures IR light radiating from objects in its field of view, often for the purpose of detecting motion.

In some cases, an integrated sensor device 165 can include more than one transmitter and/or more than one receiver. For example, an integrated sensor device 165 can include a RF transmitter, a RF receiver, and an IR transmitter. This would allow the integrated sensor device 165 to broadcast to one or more communication devices 190 a communication signal 195 using RF signals and another communication signal 195 using IR. The RF receiver of the integrated sensor device 165 can then subsequently receive a communication signal 195 from the one or more communication devices 190 in response to the RF and IR communications signals 195 broadcast by the integrated sensor device 165.

Each sensor device 165 can use one or more of a number of communication protocols. This allows a sensor device 165 to communicate with one or more components (e.g., a communication device 190 of an object 160, a WAC 185, one or more other integrated sensor devices 165) of the system 100. The communication capability of a sensor device 165 that is an integrated sensor can be dedicated to the sensor device 165 and/or shared with the controller 104 of the electrical device 102-1. When the system 100 includes multiple integrated sensor devices 165, one integrated sensor device 165 can communicate, directly or indirectly, with one or more of the other integrated sensor devices 165 in the system 100.

If the communication capability of a sensor device 165 is an integrated sensor is dedicated to the sensor device 165, then the sensor device 165 can include one or more components (e.g., a transceiver 124, a communication module 108), or portions thereof, that are substantially similar to the corresponding components described above with respect to the controller 104. A sensor device 165 can be associated with the electrical device 102-1 and/or another electrical device 102 in the system 100. A sensor device 165 can be located within the housing 103 of the electrical device 102-1, disposed on the housing 103 of the electrical device 102-1, or located outside the housing 103 of the electrical device 102-1.

In certain example embodiments, a sensor device 165 can include an energy storage device (e.g., a battery) that is used to provide power, at least in part, to some or all of the other components of the sensor device 165. In such a case, the energy storage device can be the same as, or independent of, an energy storage device or other power supply 140 of the electrical device 102-1. The optional energy storage device of the sensor module 165 can operate at all times or when the power supply 140 of the electrical device 102-1 is interrupted. Further, a sensor device 165 can utilize or include one or more components (e.g., memory 122, storage repository 130, transceiver 124) found in the controller 104. In such a case, the controller 104 can provide the functionality of these components used by the sensor device 165. Alternatively, the sensor device 165 can include, either on its own or in shared responsibility with the controller 104, one or more of the components of the controller 104. In such a case, the sensor device 165 can correspond to a computer system as described below with regard to FIG. 2. An example of an integrated sensor device is shown in FIG. 10 below.

As discussed above, the electrical device 102-1 can include one or more optional antennae 175. An antenna 175 is an electrical device or component that converts electrical power to communication signals 195 (for transmitting) and communication signals 195 to electrical power (for receiving). In transmission, a radio transmitter (e.g., transceiver 124) supplies, through the optional switch 145 when multiple antenna 175 are involved, an electric current oscillating at radio frequency (e.g., a high-frequency alternating current (AC)) to the terminals of the antenna 175, and the antenna 175 radiates the energy from the current as communication signals 195. In reception, an antenna 175, when included in the electrical device 102-1, intercepts some of the power of communication signals 195 in order to produce a tiny voltage at its terminals, that is applied to a receiver (e.g., transceiver 124), in some cases through an optional switch 145, to be amplified.

An antenna 175 can typically consist of an arrangement of electrical conductors that are electrically connected to each other (often through a transmission line) to create a body of the antenna 175. The body of the antenna 175 is electrically coupled to the transceiver 124. An oscillating current of electrons forced through the body of an antenna 175 by the transceiver 124 will create an oscillating magnetic field around the body, while the charge of the electrons also creates an oscillating electric field along the body of the antenna 175. These time-varying fields radiate away from the antenna 175 into space as a moving transverse communication signal 195 (often an electromagnetic field wave). Conversely, during reception, the oscillating electric and magnetic fields of an incoming communication signal 195 exert force on the electrons in the body of the antenna 175, causing the electrons to move back and forth, creating oscillating currents in the antenna 175.

In certain example embodiments, an antenna 175 can be disposed at, within, or on any portion of the electrical device 102-1. For example, an antenna 175 can be disposed on the housing 103 of the electrical device 102-1 and extend away from the electrical device 102-1. As another example, an antenna 175 can be insert molded into a lens of the electrical device 102-1. As another example, an antenna 175 can be two-shot injection molded into the housing 103 of the electrical device 102-1. As yet another example, an antenna 175 can be adhesive mounted onto the housing 103 of the electrical device 102-1. As still another example, an antenna 175 can be pad printed onto a circuit board within the cavity 101 formed by the housing 103 of the electrical device 102-1. As yet another example, an antenna 175 can be a chip ceramic antenna that is surface mounted. As still another example, an antenna 175 can be a wire antenna.

When there are multiple antennae 175 (or other forms of multiple communication points) as part of the electrical device 102-1, there can also be an optional switch 145, which allows for selection of one communication point at a given point in time. In such a case, each antenna 175 can be electrically coupled to the switch 145, which in turn is electrically coupled to the transceiver 124. The optional switch 145 can be a single switch device or a number of switch devices arranged in series and/or in parallel with each other. The switch 145 determines which antenna 175 is coupled to the transceiver 124 at any particular point in time. A switch 145 can have one or more contacts, where each contact has an open state (position) and a closed state (position).

In the open state, a contact of the switch 145 creates an open circuit, which prevents the transceiver 124 from delivering a communication signal 195 to or receiving a communication signal 195 from the antenna 175 electrically coupled to that contact of the switch 145. In the closed state, a contact of the switch 145 creates a closed circuit, which allows the transceiver 124 to deliver a communication signal 195 to or receive a communication signal 195 from the antenna 175 electrically coupled to that contact of the switch 145. In certain example embodiments, the position of each contact of the switch 145 is controlled by the control engine 106 of the controller 104.

If the switch 145 is a single device, the switch 145 can have multiple contacts. In any case, only one contact of the switch 145 can be active (closed) at any point in time in certain example embodiments. Consequently, when one contact of the switch 145 is closed, all other contacts of the switch 145 are open in such example embodiments.

FIG. 2 illustrates one embodiment of a computing device 218 that implements one or more of the various techniques described herein, and which is representative, in whole or in part, of the elements described herein pursuant to certain exemplary embodiments. For example, computing device 218 can be implemented in the electrical device 102-1 of FIG. 1 in the form of the hardware processor 120, the memory 122, and the storage repository 130, among other components. Computing device 218 is one example of a computing device and is not intended to suggest any limitation as to scope of use or functionality of the computing device and/or its possible architectures. Neither should computing device 218 be interpreted as having any dependency or requirement relating to any one or combination of components illustrated in the example computing device 218.

Computing device 218 includes one or more processors or processing units 214, one or more memory/storage components 215, one or more input/output (I/O) devices 216, and a bus 217 that allows the various components and devices to communicate with one another. Bus 217 represents one or more of any of several types of bus structures, including a memory bus or memory controller, a peripheral bus, an accelerated graphics port, and a processor or local bus using any of a variety of bus architectures. Bus 217 includes wired and/or wireless buses.

Memory/storage component 215 represents one or more computer storage media. Memory/storage component 215 includes volatile media (such as random access memory (RAM)) and/or nonvolatile media (such as read only memory (ROM), flash memory, optical disks, magnetic disks, and so forth). Memory/storage component 215 includes fixed media (e.g., RAM, ROM, a fixed hard drive, etc.) as well as removable media (e.g., a Flash memory drive, a removable hard drive, an optical disk, and so forth).

One or more I/O devices 216 allow a customer, utility, or other user to enter commands and information to computing device 218, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 is connected to a network (not shown) (e.g., a LAN, a WAN such as the Internet, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain exemplary embodiments. Further, one or more embodiments is implemented on a distributed system having one or more nodes, where each portion of the implementation (e.g., control engine 106) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

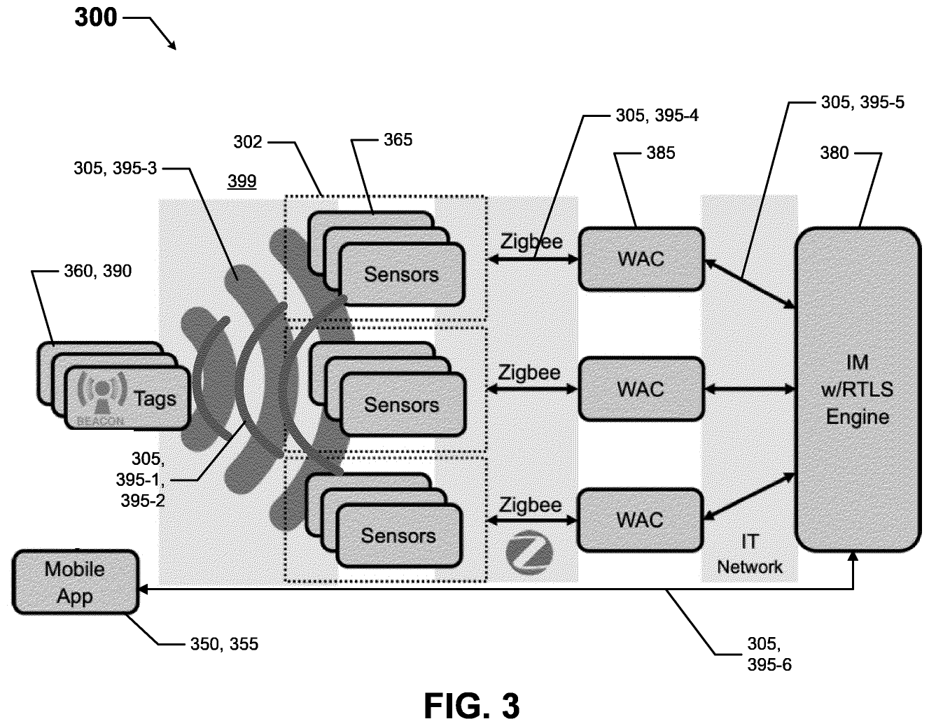

FIG. 3 shows a diagram of another RTLS system 300 in accordance with certain example embodiments. Referring to FIGS. 1 through 3, the RTLS system 300 includes a user 350 with a user system 355, multiple objects 360 each having a communication device 390 (sometimes called a tag 390), a number of electrical devices 302 each having one or more sensor devices 365, a number of WACs 385, and a network manager 380 (in this case also called an insight manager (IM) with a RTLS engine). Each of these components of the system 300 of FIG. 3 can be substantially the same as the corresponding component of the RTLS system 100 of FIG. 1. For example, each sensor device 365 can include a Zigbee-enabled transceiver, a BLE-enabled receiver, a PIR sensor, and an active IR receiver.

In this particular case, the communication devices 390 of the objects 360 are the physical entities that are tracked by the RTLS system 300. In this example, the communication devices 390 have a RF receiver, an IR receiver, and a RF transmitter. Also, in this example, the transceiver of each electrical device 302 and/or sensor device 365 can include RF receiver, an IR transmitter, and a RF transmitter. The electrical devices 302, the sensor devices 365, and the communication devices 390 of the objects 360 are located in a volume of space 399.

Initially, one or more of the electrical devices 302 and/or sensor devices 365 broadcast communication signals 395-1 in the form of RF signals (e.g., using BLE, using ultra-wideband) that are received by the RF receivers of the communication devices 390 of the objects 360. At approximately the same time, one or more of the electrical devices 302 and/or sensor devices 365 broadcast communication signals 395-2 in the form of IR signals that are received by the IR receivers of the communication devices 390 of the objects 360 when those communication devices 390 are within a line-of-sight of the broadcasting electrical devices 302 and/or sensor devices 365. As a result of the line-of-sight requirement, fewer communication signals 395-2 in the form of IR signals are received by a communication device 390 compared to the number of communication signals 395-1 in the form of RF signals, which can travel through walls and other objects. Communication signals 395-1 and communication signals 395-2 are broadcast using wireless communication links 305.

In response to receiving communication signals 395-1 and/or communication signals 395-2, each communication device 390 can then use its RF transmitter to “beacon” communication signals 395-3 in the form of RF signals (e.g., using BLE, using ultra-wideband) that are received by the RF receivers of the electrical devices 302 and/or sensor devices 365. In certain example embodiments, a communication device 390 only broadcasts communication signals 395-3 when the communication device 390 receives both communication signals 395-1 and/or communication signals 395-2. In other words, if a communication device 390 only receives the communication signals 395-1 in the form of RF signals and fails to receive the communication signals 395-2 in the form of IR signals, then the communication device 390 fails to send the communication signals 395-3.

A beacon is a broadcast message that, at a minimum, identifies the object 360 associated with the sending communication device 390 and an identification of the electrical device 302 that sent communication signals 395-1 and communication signals 395-2. The communication signals 395-3 are broadcast using wireless communication links 305. In addition to extracting data (e.g., whether a communication device 390 received both communication signal 395-1 and communication signal 395-2) within each communication signal 395-3, the electrical devices 302 and/or integrated sensor devices 365 can measure one or more characteristic (e.g., the RSSI) of the communication signals 395-3.

This RSSI information and other characteristics of the communication signals 395-3 can be key pieces of data that allow a controller of an electrical device 302, a WAC 385 and/or the network manager 380 to locate, in real time, the communication device 390 (and corresponding object 360) within the volume of space 399 (e.g., in X-Y coordinates, in X-Y-Z coordinates). As used herein, “real time” refers to a user's perspective of the system and means that objects can be located within the time in which the signals are transmitted and processed, such as a few milliseconds to within a few seconds, which time is virtually real time from the user's perspective.

Upon processing the communication signals 395-3, an electrical device 302 and/or sensor device 365 can generate and send communication signals 395-4 to one or more WACs 385 using, in this example, Zigbee-enabled communication links 305. In this case, an electrical device 302 and/or an integrated sensor device 365 is a Zigbee-enabled device as well as a BLE-enabled device, and so an electrical device or a sensor device 365 can be paired with a single WAC 385.

In certain example embodiments, the WACs 385, upon receiving the communication signals 395-4 from the sensor devices 365 and/or electrical devices 302 on the Zigbee-enabled communication links 305, generate and send communication signals 395-5 over communication links 305 to the network manager 380, which process all of this information (e.g., using one or more algorithms 133) to locate each object 360 within the volume of space 399 in real time. The network manager 380 can store this information and use it for trending analysis, predictive analysis, reporting, and/or any other analysis that may be useful.

Once all of the location information is processed by the network manager 380, the network manager 380 can send some or all of this information, either automatically or upon request, to the user system 355 of the user 350. Such information can be contained in communication signals 395-6 send using communication links 305. In such a case, the user system 355 can include an app or other specialized software to allow the user 350 to view and/or manipulate the location information.

BLE proximity methods are widely used in the industry to estimate the distance between a BLE transmitter (in this case, a communication device 390 of an object 360) and a BLE receiver (in this case, a sensor device 365 or other electrical devices 302). In a dense and uniformly distributed infrastructure of electrical devices 302 (e.g., a lighting system), these methods can be optimized to achieve greater accuracy by comparing the RSSI and/or other characteristics (e.g., time, AoA) of the communication signals 395 at many BLE receivers, by determining whether the communication signals 395-2 in the form of IR signals were received by a communication device 390, and performing various calculations (by a WAC 385 or network manager 380) to estimate the location of an object 360.

Reasonable accuracy can be expected with these methods, but two significant challenges are encountered using BLE communication systems. First, the large number of electrical devices 302 (sensor devices 365 or nodes) creates large amounts of data, and the communication network of the system 300 has limited bandwidth. Not all data that is transmitted is useful in establishing the location of an object 360, and care must be taken to provide the best data possible to a WAC 385 or the network manager 380 while still maintaining a healthy (e.g., not data-constrained) network. In other words, the principal purpose (e.g., lighting) of the system 300 for which the electrical devices 302 is designed should not be affected by the efforts of the system 300 to also locate one or more objects 360 in real time.

Second, no matter how accurate the location estimations of objects 360 are, there can be challenges in achieving reliable room-level or even floor-level accuracy of locating an object 360 using only communication signals 395-1 in the volume of space 399 because RF signals (e.g., transmitted at 2.4 GHz in a BLE-enabled communication network) can penetrate barriers such as walls and floors. As a result, these barriers can cause the location of an object 360 to be falsely identified. By verifying receipt of the communication signals 395-2 in the form of IR signals, which require a line-of-sight and so cannot penetrate walls, example embodiments can more accurately locate objects 360 in real time in volumes of space that have such barriers and/or present other challenges to existing location methods.

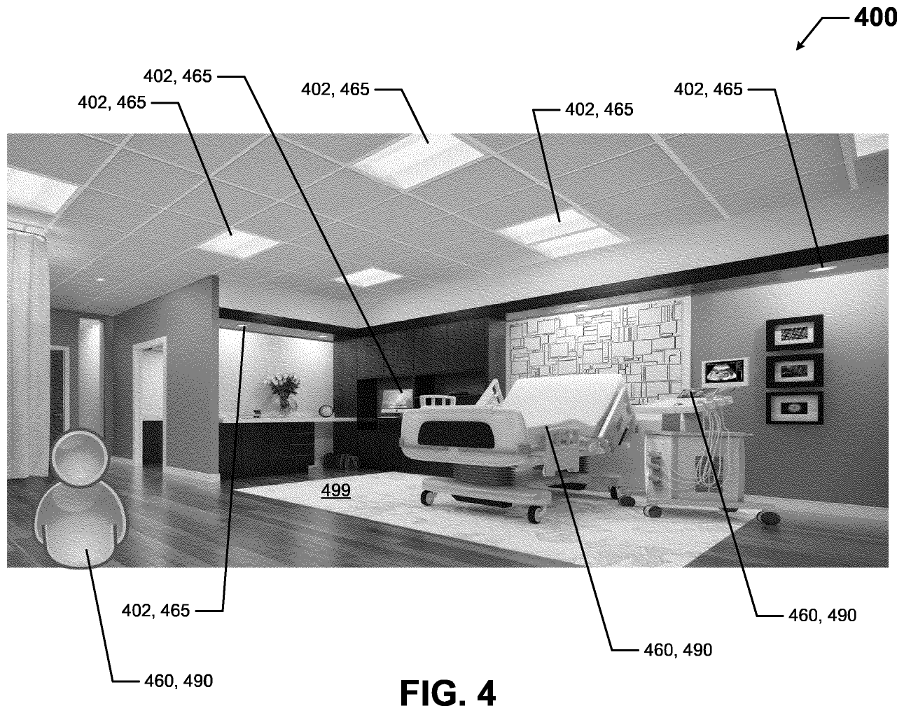

FIG. 4 shows a lighting system 400 that can be used for real-time location of an object 460 in accordance with certain example embodiments. Referring to FIGS. 1 through 4, the lighting system 400 includes a number of electrical devices 402, principally in the form of light fixtures, located in a volume of space 499 that includes a hospital room. A lighting system, such as system 400, provides unique advantages for implementing an example RTLS because the density of the electrical devices (light fixtures) supports a dense network of sensors for locating and tracking objects. Of the electrical devices 402 that are light fixtures, there are seven troffer light fixtures and five down can light fixtures disposed in the ceiling. There is also an electrical device 402 in the form of a computer monitor. In this case, each electrical device 402 includes a sensor device 465, substantially similar to the sensor devices 165 discussed above. There are also three objects 460 shown in FIG. 4. One object 460 is a test cart, another object 460 is a person (e.g., a doctor, a nurse, a patient, a visitor), and the remaining object 460 is a bed. Each object 460 in this case includes a communication device 490 that is capable of communicating with the electrical devices 402 and/or sensor devices 465 in the volume of space 499.

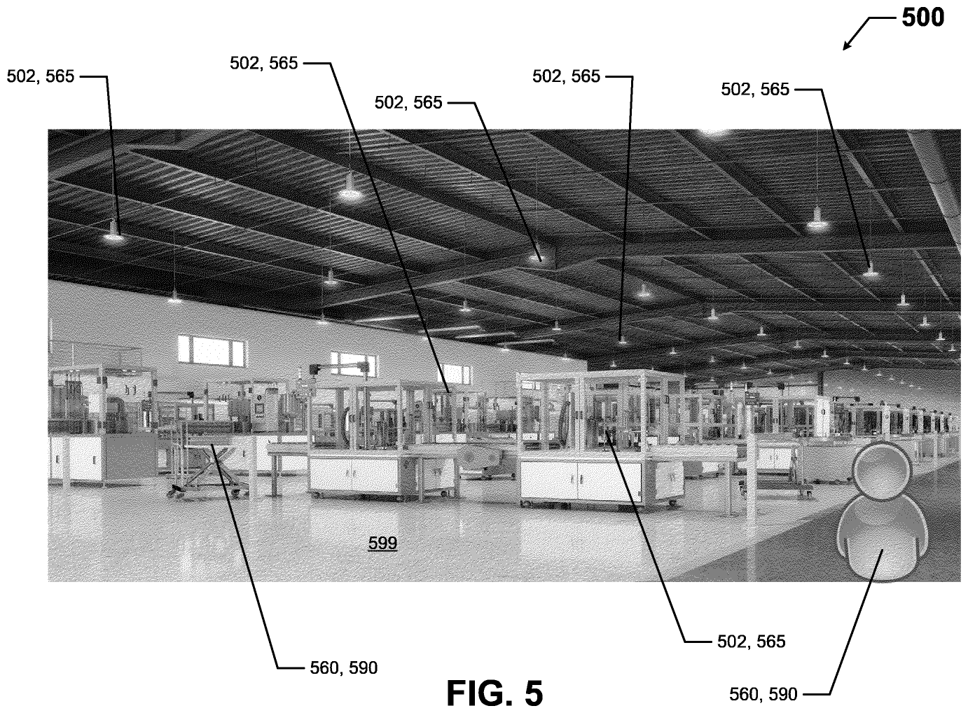

FIG. 5 shows a lighting system 500 that can be used for real-time location of an object 560 in accordance with certain example embodiments. Referring to FIGS. 1 through 5, the lighting system 500 includes a number of electrical devices 502, principally in the form of light fixtures, located in a volume of space 599 that includes a manufacturing facility. Of the electrical devices 502 that are light fixtures, there are at least 56 Hi-Bay light fixtures suspended from the ceiling and at least 30 work stations located on the floor. In this case, each electrical device 502 includes a sensor device 565, substantially similar to the sensor devices 165 discussed above. There are also two objects 560 shown in FIG. 5, where one object 560 is a person (e.g., an employee) and the other object 560 is a cart. Each object 560 in this case includes a communication device 590 that is capable of communicating with the electrical devices 502 and/or the sensor devices 565.

FIGS. 6A and 6B show a side and top view, respectively, of a system 600 in which an object 660 (including its corresponding communication device 690) is located in volume of space 699 in accordance with certain example embodiments. Referring to FIGS. 1 through 6B, also located in the volume of space 699 of FIGS. 6A and 6B are three electrical devices 602 (specifically, electrical device 602-1, electrical device 602-2, and electrical device 602-3), in the form of light fixtures. As discussed above, the volume of space 699 can be of any size and/or in any location. For example, the volume of space 699 can be one or more rooms in an office building.

As shown in FIGS. 6A and 6B, all of the electrical devices 602 can be located in the volume of space 699. Alternatively, one or more of the electrical devices 602 can be located outside the volume of space 699, as long as the communication signals 195 sent by the transceiver (e.g., transceiver 124) of an electrical device 602 are received by the communication device 690 of the object 660, and as long as the communication signals sent by the communication device 690 of the object 660 are received by the transceiver of the corresponding electrical device 602, as applicable. The electrical devices 602, the object 660, and the communication device 690 are substantially similar to the electrical device 102-1, the object 160, and the communication device 190 of FIG. 1 above.

Each of the electrical devices 602 can include one or more sensor devices 665. In this example, electrical device 602-1 includes sensor device 665-1, electrical device 602-2 includes sensor device 665-2, and electrical device 602-3 includes sensor device 665-3. Such sensor devices 665 can include one or more components. For example, each of the sensor devices 665 of the electrical devices 602 of FIGS. 6A and 6B can include a Zigbee-enabled transceiver, a BLE-enabled receiver, a PIR sensor, and an active IR receiver. In such a case, the BLE-enabled receiver of the sensor device 665, whether on its own or in conjunction with the controller (e.g., controller 104) of the electrical device 602, can determine the signal strength of the communication signals 195 received from the communication device 690 of the object 660.

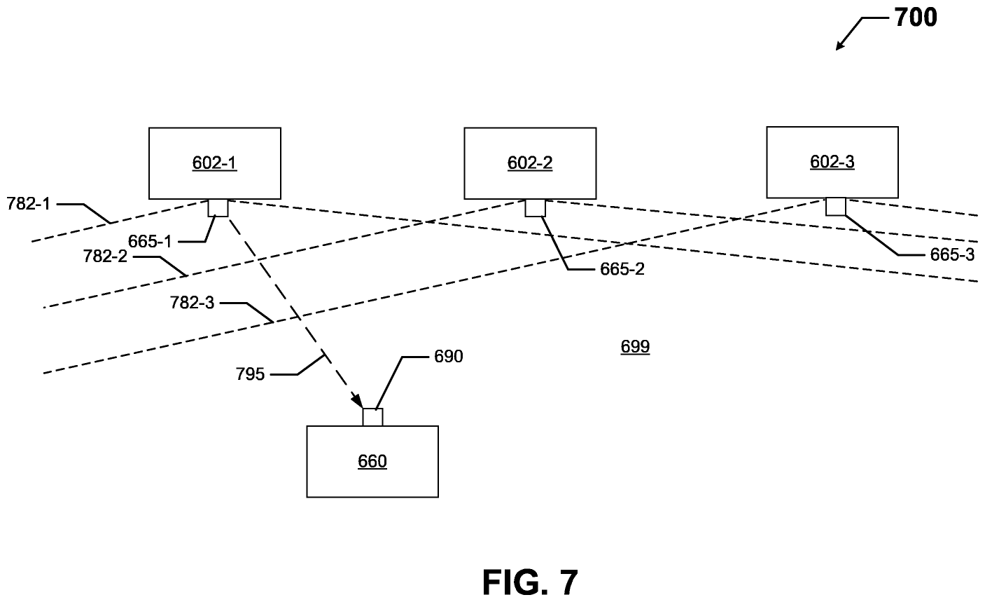

If the sensor devices 665 of the electrical devices 602 are used to communicate with the communication device 690 of the object 660, then it is the sensor devices 665 that have the broadcasts ranges 782 (discussed below with respect to FIG. 7). In such a case, sensor device 665-1 of electrical device 602-1 has broadcast range 782-1 inside of which the sensor device 665-1 broadcasts communication signals (e.g., RF signals, IR signals). Similarly, sensor device 665-2 of electrical device 602-2 has broadcast range 782-2 inside of which the sensor device 665-2 broadcasts signals, and sensor device 665-3 of electrical device 602-3 has broadcast range 782-3 inside of which the sensor device 665-3 broadcasts signals.

FIG. 7 shows the system 700 of FIGS. 6A and 6B when a communication signal 795 is sent by one of the electrical devices 602 in accordance with certain example embodiments. Referring to FIGS. 1 through 7, electrical device 602-1 broadcasts a communication signal 795. Each electrical device 602 has a broadcast range 782. In this case, electrical device 602-1 has broadcast range 782-1, electrical device 602-2 has broadcast range 782-2, and electrical device 602-3 has broadcast range 782-3. Since the communication device 690 of the object 660 is located within the broadcast range 782-1 for electrical device 602-1, the communication device 690 of the object 660 receives the communication signal 795.

In the event that the sensor devices 665 are used to communicate with the communication device 690 of the object 660, sensor device 665-1 can have broadcast range 782-1. In such a case, sensor device 665-1 can send (e.g., broadcast) the communication signal 795 into the volume of space 699, and the communication device 690 of the object 660 receives the communication signal 795 because the communication device 690 of the object 660 is within the broadcast range 782-1. The communication signal 795 can be sent, as an example, using BLE.

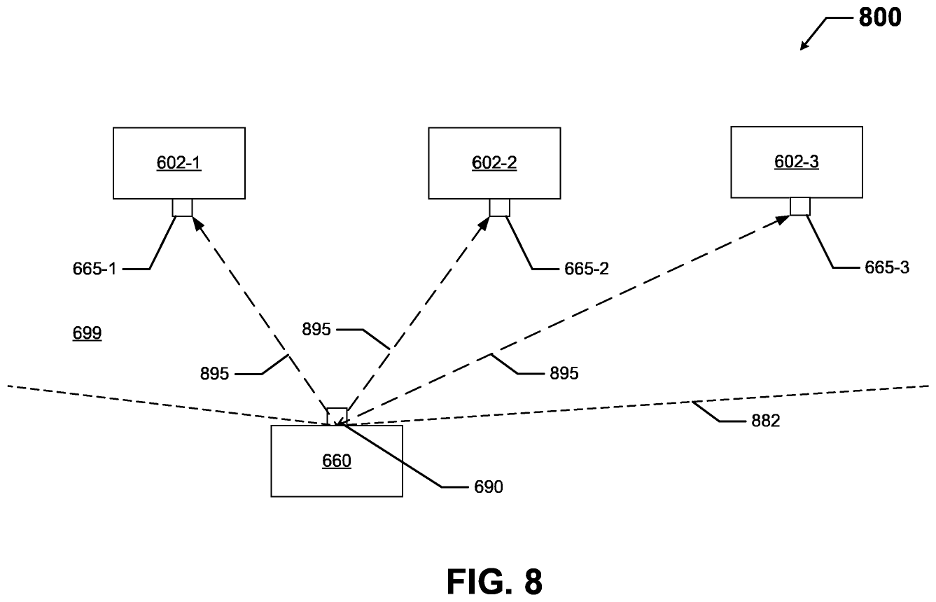

FIG. 8 shows the system 800 of FIGS. 6A through 7 when a communication signal 895 is sent by the communication device 690 of the object 660 in accordance with certain example embodiments. Referring to FIGS. 1 through 8, the communication signal 895 sent by the communication device 690 of the object 660 can be in response to the communication signal 795 sent by electrical device 602-1, as shown in FIG. 7. Alternatively, the communication device 690 of the object 660 can send the communication signal 895 independent of any other component (e.g., an electrical device 602) or factor. As discussed above, the communication signal 895 broadcast by the communication device 690 of the object 660 can include the UUID of the object 660 (or portion thereof) as well as other code, such as, for example, identifying information of the electrical device 602-1 that sent the communication signal 795.

The communication device 690 of the object 660 has a broadcast range 882, and all three of the electrical devices 602 are located within the broadcast range 882 of the communication device 690 of the object 660. As a result, as shown in FIG. 8, all three of the electrical devices 602 receive the communication signal 895 broadcast by the communication device 690 of the object 660. When each electrical device 602 receives the communication signal 895 broadcast by the communication device 690 of the object 660, that electrical device 602 measures the signal strength (e.g., the RSSI value) of the communication signal 895.

For example, since the communication device 690 of the object 660 appears to be equidistant between electrical device 602-1 and electrical device 602-2, the signal strength of the communication signal 895 measured by electrical device 602-1 and electrical device 602-2 should be substantially the same. Also, since electrical device 602-3 is further away from the communication device 690 of the object 660 compared to electrical device 602-1 and electrical device 602-2, the signal strength of the communication signal 895 measured by electrical device 602-3 should be less than what is measured by electrical device 602-1 and electrical device 602-2.

As discussed above, in the event that the sensor devices 665 are used to communicate with the communication device 690 of the object 660, sensor device 665-1, sensor device 665-2, and sensor device 665-3 can each receive the communication signal 895 broadcast by the communication device 690 of the object 660 because sensor device 665-1, sensor device 665-2, and sensor device 665-3 area all within the broadcast range 882 of the communication device 690 of the object 660. The communication signal 895 can be sent, as an example, using BLE.

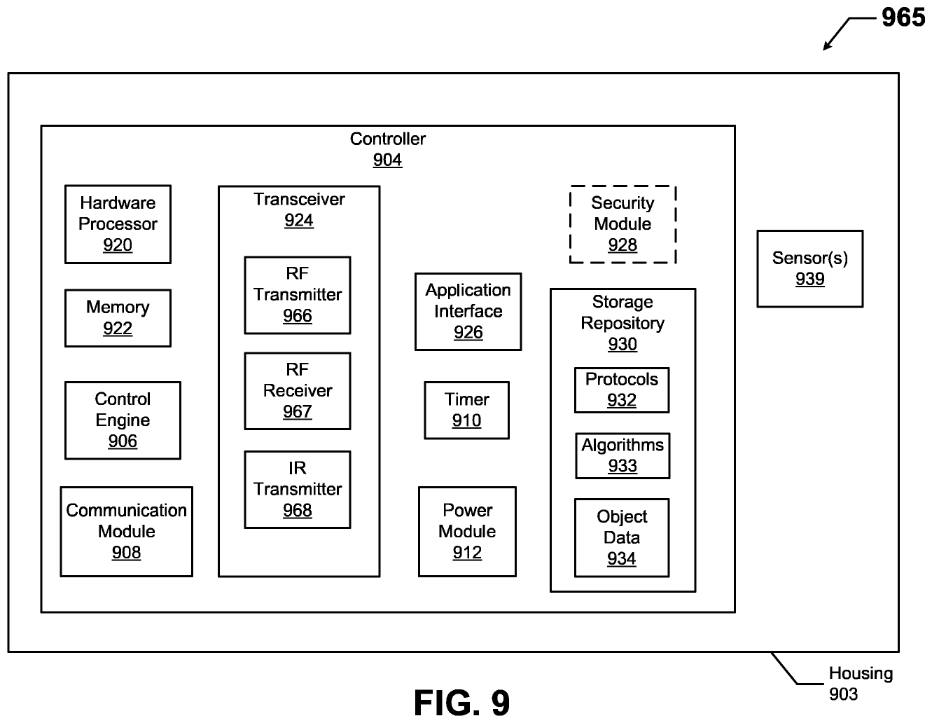

FIG. 9 shows a diagram of an integrated sensor module 965 in accordance with certain example embodiments. Referring to FIGS. 1 through 9, the integrated sensor module 965 of FIG. 9 can include one or more of a number of components. Such components, can include, but are not limited to, a controller 904 (which can include, for example, a control engine 906, a communication module 908, a timer 910, a power module 912, a storage repository 930, a hardware processor 920, a memory 922, one or more transceivers 924, an application interface 926, and, optionally, a security module 928), a housing 903, and one or more sensors 939. The components shown in FIG. 9 are not exhaustive, and in some embodiments, one or more of the components shown in FIG. 9 may not be included in an example integrated sensor device 965. Any component of the example integrated sensor device 965 can be discrete, combined with one or more other components of the integrated sensor device 965, and/or shared with the controller 94 of the electrical device 92-1 associated with the integrated sensor device 965.

The housing 903, the controller 904, the control engine 906, the communication module 908, the timer 910, the power module 912, the storage repository 930 (which can include protocols 931, algorithms 932, and object data 934), the hardware processor 920, the memory 922, the one or more transceivers 924, the application interface 926, and the security module 928 can be substantially the same as the corresponding components of the controller 104 discussed above with respect to FIG. 1.

In the case of the power module 912 of the integrated sensor device 965, the power module 912 can be substantially the same as, at least in part, the power module 112 and/or the power supply 140 of the electrical device 92-1. Each of the one or more sensors 939 of the integrated sensor device 965 are the components that actually measure one or more parameters, as with the sensors of the sensor devices 165 of FIG. 1. An example of a sensor 939 is a PIR sensor. Each component of the integrated sensor device 965 can be disposed within, on, or external from a housing 938 of the integrated sensor device 965.

Also, in this case, FIG. 9 shows some of the different parts of the transceiver 924. Specifically, the transceiver 924 of FIG. 9 includes a RF transmitter 966, a RF receiver 967, and an IR transmitter 968. The RF transmitter 966 and the RF receiver 967 can send and receive RF communication signals using one or more communication protocols (e.g., BLE, ultra-wideband, Zigbee). The IR transmitter 968 can broadcast or otherwise send IR communication signals.

FIG. 10 shows a diagram of a communication device 1090 of an object (e.g., object 160) in accordance with certain example embodiments. Referring to FIGS. 1 through 10, the communication device 1090 of FIG. 10 can be substantially the same as the communication device 190 of FIG. 1, except as described below. The communication device 1090 can include one or more of a number of components. Such components, can include, but are not limited to, a controller 1004 (which can include, for example, a control engine 1006, a communication module 1008, a timer 1010, a power module 1012, a storage repository 1030, a hardware processor 1020, a memory 1022, one or more transceivers 1024, an application interface 1026, and, optionally, a security module 1028), a housing 1003, and one or more sensors 1039.

The components shown in FIG. 10 are not exhaustive, and in some embodiments, one or more of the components shown in FIG. 10 may not be included in an example communication device 1090. Any component of the example communication device 1090 can be discrete, combined with one or more other components of the communication device 1090. The housing 1003, controller 1004, the control engine 1006, the communication module 1008, the timer 1010, the power module 1012, the storage repository 1030 (which can include protocols 1031, algorithms 1032, and object data 1034), the hardware processor 1020, the memory 1022, the one or more transceivers 1024, the application interface 1026, and the security module 1028 can be substantially the same as the corresponding components of the controller 104 discussed above with respect to FIG. 1.

In the case of the power module 1012 of the communication device 1090, the power module 1012 can be substantially the same as, at least in part, the power module 102 and/or the power supply 140 of the electrical device 102-1 of FIG. 1. Each of the one or more sensors 1039 of the communication device 1090 can measure one or more parameters, as with the sensors of the sensor devices 165 of FIG. 1. An example of a sensor 1039 is a PIR sensor.

Also, in this case, FIG. 10 shows some of the different parts of the transceiver 1024. Specifically, the transceiver 1024 of FIG. 10 includes a RF transmitter 1066, a RF receiver 1067, and an IR receiver 1069. The RF transmitter 1066 and the RF receiver 1067 can send and receive RF communication signals using one or more communication protocols (e.g., BLE, ultra-wideband, Zigbee). The IR receiver 1069 can receive IR communication signals that are within a line-of-sight of the sending electrical device (e.g., electrical device 102-1) or sensor device (e.g., sensor device 965).

In one or more example embodiments, an integrated sensor device or other electrical device is used to more efficiently locate an object in a volume of space relative to current systems and methods. For example, the objects in a hospital room, as illustrated in FIG. 4, or the objects in a manufacturing facility, as shown in FIG. 5, can be located with greater precision and/or efficiency by using IR signals in combination with radio frequency signals. The integrated sensor device combines both sensing ability (measuring one or more parameters) and multiple communication protocols and/or methods (e.g., IR, Zigbee, BLE, ultra-wideband) that can be used. In certain cases, the integrated sensor device or other electrical device can communicate in multiple protocols and/or methods.

With certain sensor devices, multiple sensors (e.g., PIR, proximity) can be used simultaneously to more accurately locate an object in a volume of space. In certain example embodiments, a communication device of an object can include multiple receivers (e.g., IR receiver, RF receiver) to more accurately determine the location of the object within a volume of space. Example embodiments can be used in new systems or retrofit into existing systems. Example embodiments include new or updated software so that a network of integrated sensor devices or other electrical devices can work more efficiently together to provide location information, based on RSSI values and/or other characteristics of communication signals received from a communication device of an object, to a network manager or similar component of the system. Example embodiments can provide real-time location of an object in volume of space. Using example embodiments described herein can improve communication, safety, maintenance, costs, and operating efficiency.

Accordingly, many modifications and other embodiments set forth herein will come to mind to one skilled in the art to which example embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of this application. Although specific terms are employed herein, they are used in a generic and descriptive sense only and not for purposes of limitation.

1. A system for locating an object in a volume of space, comprising:
a communication device (CD) of the object disposed in the volume of space, wherein the communication device comprises a CD radio frequency (RF) receiver, a CD RF transmitter, and a CD infrared (IR) receiver;
a first electrical device of a plurality of electrical devices disposed in the volume of space, wherein the first electrical device comprises at least one first sensor, a first RF receiver, a first IR transmitter, and a first RF transmitter, wherein the first RF transmitter broadcasts a first communication signal, wherein the first IR transmitter broadcasts a second communication signal, and wherein the first RF receiver receives, in response to the first communication signal received by the CD RF receiver and the second communication signal received by the CD IR receiver, a third communication signal broadcast by the CD RF transmitter of the communication device; and
a controller communicably coupled to the plurality of electrical devices, wherein the controller receives a fourth communication signal sent by the first RF transmitter of the first electrical device, wherein the fourth communication signal comprises a first identification of the object and a second identification of the first electrical device, wherein the fourth communication signal is associated with a signal strength of the third communication signal received by the first RF receiver of the first electrical device;
wherein the communication device fails to broadcast the third communication signal when the CD RF receiver receives the first communication signal but when the CD IR receiver fails to receive the second communication signal.

2. The system of claim 1, further comprising:
a network manager communicably coupled to the controller, wherein the network manager receives a fifth communication signal from the controller, wherein the fifth communication signal comprises the first identification of the object and the second identification of the first electrical device, wherein the network manager determines a location of the object in the volume of space based on the fifth communication signal.

3. The system of claim 1, wherein the first electrical device comprises an integrated sensor device.

4. The system of claim 1, wherein the first electrical device comprises a light fixture.

5. (canceled)

6. The system of claim 1, wherein the controller determines that the third communication signal was not received by the first electrical device.

7. The system of claim 1, wherein the first communication and the third communication are transmitted using Bluetooth Low Energy, and wherein the fourth communication is transmitted using Zigbee.

8. The system of claim 1, wherein the first communication and the third communication are transmitted using ultra-wideband, and wherein the fourth communication is transmitted using Zigbee.

9. The system of claim 1, wherein the first RF receiver comprises a Bluetooth Low Energy receiver and a Zigbee transmitter.

10. The system of claim 1, wherein the CD RF receiver is a Bluetooth Low Energy receiver.

11. The system of claim 1, wherein the signal strength comprises a received signal strength indicator.

12. The system of claim 1, wherein the communication device broadcasts the third communication signal when the CD IR receiver receives the second communication signal, wherein the third communication signal comprises the second identification of the first electrical device.

13. (canceled)
